(19) United States
(12) Patent Application Publication
(10) Pub. No.: US 2010/0001531 A1
(43) Pub. Date: Jan. 7, 2010

(54) Vertical axis wind turbine powered electricity generating system for charging electric automobile batteries

(76) Inventor: Harry Hillar Kulde, Cherry Valley, CA (US)

Correspondence Address: HARRY HILLAR KULDE, 10580 BEL AIR DR., CHERRY VALLEY, CA, 92223-5583, US

(21) Appl. No.: 12/217,480

(22) Filed: Jul. 7, 2008

(51) Int. Cl. F03D 9/00; H02K 53/00

(52) U.S. Cl. 290/55; 415/916

(57) ABSTRACT

A Vertical Axis Wind Turbine (VAWT) powered electricity generation system for charging AC plug-in and/or solar powered automobile batteries. Said system is mounted in front of an automobile and includes a Permanent Magnet Generator (PMG). Said PMG is located within the said VAWT and is connected to a controller. The electricity output from said PMG is governed by the forward speed of the automobile. Said controller regulates the voltage, and transmits electric current to the battery charger.

### BACKGROUND OF THE INVENTION

All electric battery powered automobiles, whether plug-in or solar, are suitable for local driving and require the recharging of the batteries for longer driving distances. To increase the said automobiles driving distances, this invention uses kinetic energy from the wind, when the automobile is in motion, and coverts it into mechanical power. Said VAWT rotates the said PMG shaft and converts mechanical power into electrical power. With improved battery technology said system will make the all electric automobile suitable for 100 plus mile driving distances without stopping and waiting for the recharge.

The small VAWT with improved materials and blade design will be suitable for wind speeds over 100 MPH. No gearing or other speed increaser is required to increase the RPM of the PMG shaft.

### BRIEF DESCRIPTION OF THE DRAWINGS

FIG. 1. Shows the location of the VAWT 1 mounted between supporting brackets 3 in front of an automobile, the brake 4 and the vents 5.

FIG. 2. Shows VAWT 1 details with Blades 6 and PMG 2. Rods 7 connect the said VAWT 1 to base 8 mounted on said PMG shaft 9. The said PMG 2 is mounted between brackets 2 and supported by thrust bearings 10.

### BRIEF SUMMARY OF THE INVENTION

This is a unique invention with a single VAWT mounted in front of the automobile in the space which is normally utilized by the motor. The PMG is mounted within the VAWT and connected directly to VAWT.

### Citations

| U.S. Pat. No. | Title | Issue date |
|---|---|---|
| 4012163 | Wind driven power generator | Mar. 6, 1977 |
| 4142822 | Panemone windmill | Mar. 6, 1979 |
| 3986785 | Vertical axis wind motor | Oct. 19, 1976 |
| 5462439 | Charging batteries of electric vehicle | Oct. 31, 1995 |
| 3529229 | Electric car battery recharge system | September 1970 |
| 5166584 | Electric vehicle | Nov. 24, 1992 |
| 6313394 | Electric vehicle photovoltaic | Nov. 6, 2001 |
| | charging system | |
| 4086498 | Wind powered rotary electric | Apr. 25, 1978 |
| | generator | |
| 5133637 | Vertical axis wind turbine generator | Jul. 28, 1992 |
| 6740989 | Vertical axis wind turbine | May 25, 2004 |
| 6870280 | Vertical axis wind turbine | Mar. 22, 2005 |
| 6309172 | Wind turbine with low vertical axis | Oct. 30, 2001 |
| 5391926 | Wind turbine particularly suited for | Feb. 21, 1995 |
| | high-wind conditions | |

### Referenced By

| U.S. | | |
|---|---|---|
| Pat. No. | Title | Issue date |
| 3971454 | System for generating electrical energy to | Jul. 27, 1976 |
| | supply power to propel vehicles | |
| 7147069 | Wind turbine driven generator system for a | Dec. 12, 2006 |
| | motor vehicle | |
| 4075545 | Charging system for automobile batteries | Feb.1. 1978 |
| 4423368 | Turbine air battery charger & power unit | Dec. 27, 1983 |
| 4019828 | Wind driven apparatus | Apr. 26, 1977 |
| 6857492 | Airflow driven electrical generator for a | Feb. 22, 2005 |
| | moving vehicle | |
| 4254843 | Electrically powered vehicle | Mar. 10, 1981 |
| 4168759 | Automobile with wind driven generator | Sep. 25, 1979 |
| 6838782 | Wind energy capturing device for moving | Jan. 4, 2005 |
| | vehicles | |
| 4093035 | Fluid mill powered vehicle | Jun. 6, 1978 |
| 5680032 | Wind-powered battery charging system | Oct. 21, 1997 |
| 5296746 | Extended range charging system for | Mar. 22, 1994 |
| | electrical vehicle | |

What is claimed:

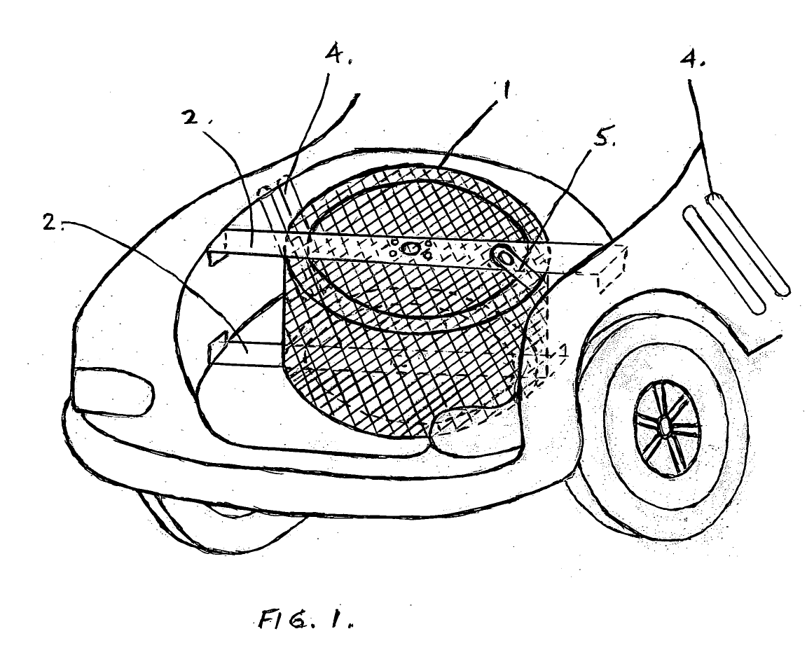

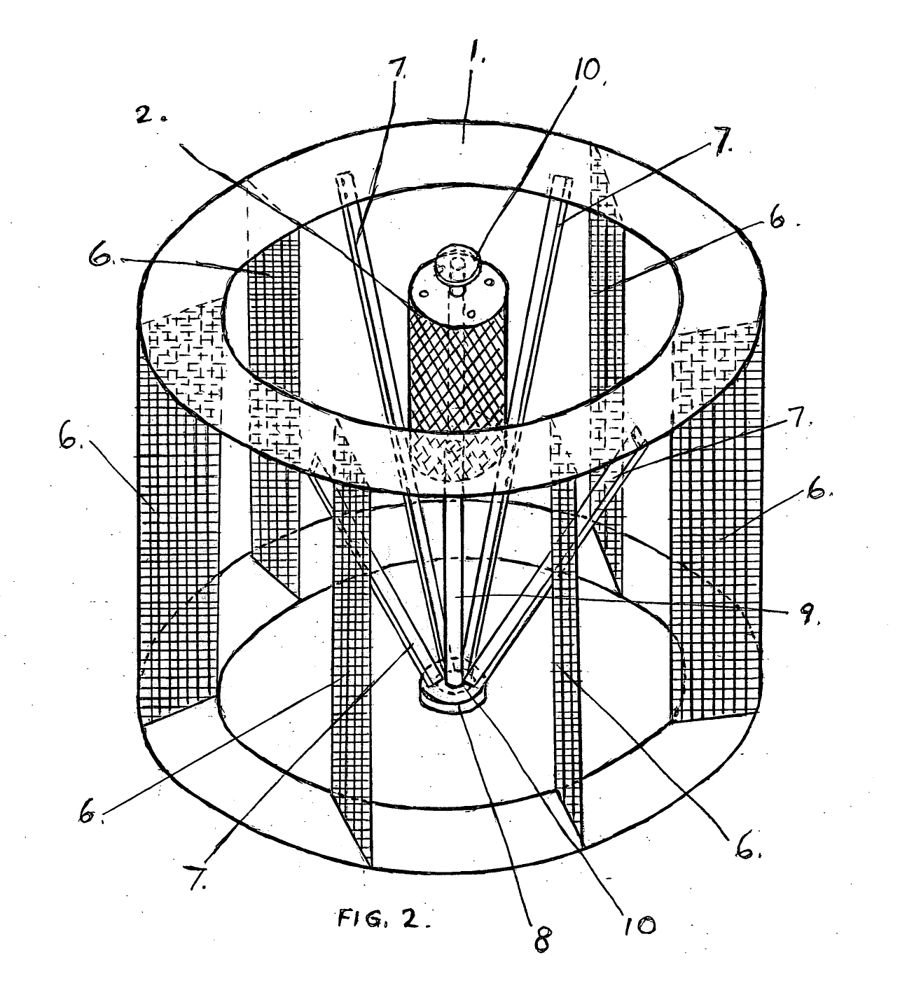

1. A system of charging electric automobile batteries when the vehicle is in motion, FIG. 1., consisting of the following:
1. A Vertical Axis Wind Turbine (VAWT) 1with Permanent Magnet Generator (PMG) 2, FIG. 2., is mounted between the supporting brackets 3 in front of AC plug-in or solar powered automobiles.
2. Forward motion of the automobile directs the wind flow through the front grille to said VAWT and the exhausted air is expelled through vents 4.
3. A manual or an electric brake 5 for stopping the rotation of the said VAWT blades, when the automobile is stationary.
4. Said invention can be utilized in hybrid automobiles when powered with rear engines.
